(19) United States
(12) Patent Application Publication
(10) Pub. No.: US 2025/0271989 A1
(43) Pub. Date: Aug. 28, 2025

(54) TARGET INFORMATION DISPLAY METHOD AND RELATED DEVICE

(71) Applicant: DOUYIN VISION CO., LTD., Beijing (CN)

(72) Inventor: Yong TU, Beijing (CN)

(21) Appl. No.: 19/025,528

(22) Filed: Jan. 16, 2025

(30) Foreign Application Priority Data
Feb. 26, 2024 (CN) 202410211426.5

(51) Int. Cl. G06F 3/04855; G06F 3/04847

(52) U.S. Cl. CPC G06F 3/04855; G06F 3/04847; G06F 2203/04803

(57) ABSTRACT

The present disclosure provides a target information display method, including: acquiring a page scroll distance of a main page window, intercepting target information for display in an additional information window from a candidate information page based on the page scroll distance, where the additional information window is located in the main page window and moves with page scrolling of the main page window; and displaying the target information in the additional information window. The present disclosure further provides a target information display apparatus, an electronic device, a storage medium, and a program product.

### CROSS-REFERENCE TO RELATED APPLICATIONS

This application claims priority to Chinese Patent Application No. 202410211426.5, filed on Feb. 26, 2024, which is incorporated herein by reference in its entirety.

### TECHNICAL FIELD

The present disclosure relates to the field of computer technology, and in particular, to a target information display method and related device.

### BACKGROUND

In various Internet applications, due to the limited display screen size used by users, in order not to excessively interfere with the users, promotional information is usually mixed in a main page window in the form of an additional information window, and the additional information window usually scrolls with the scrolling of the page. Considering the screen size of the client and the interference to users, the size of the additional information window is usually set to be small, and therefore, the amount of promotional information that can be carried in the additional information window is also usually very limited.

### SUMMARY

In view of this, an embodiment of the present disclosure provides a target information display method, which can carry more target information in a limited additional information window space without being limited by the size of the additional information window.

The target information display method according to the embodiment of the present disclosure includes: acquiring a page scroll distance of a main page window: intercepting target information for display in an additional information window from a candidate information page based on the page scroll distance, where the additional information window is located in the main page window and moves with page scrolling of the main page window; and displaying the target information in the additional information window.

In the embodiment of the present disclosure, the acquiring the page scroll distance includes: listening for a page scroll event of the main page window; in response to listening for the page scroll event, reading a scroll height of the main page window; and using the scroll height of the page window as the page scroll distance.

In the embodiment of the present disclosure, the reading the scroll height of the main page window includes: reading an attribute value that represents a current position of a vertical scroll bar of the main page window as the scroll height of the page window.

In the embodiment of the present disclosure, the attribute value that represents the current position of the vertical scroll bar of the main page window includes: a window.scrollY attribute value, a window.pageYOffset attribute value, or a document.documentElement.scrollTop attribute value.

In the embodiment of the present disclosure, the intercepting the target information for display in the additional information window from the candidate information page based on the page scroll distance includes: determining a first line position of the target information based on the page scroll distance; and intercepting information within a height of the additional information window starting from the first line position of the candidate information page as the target information.

In the embodiment of the present disclosure, the determining the first line position of the target information based on the page scroll distance includes: setting the page scroll distance as the first line position of the target information.

In the embodiment of the present disclosure, a height of the candidate information page is the same as a height of the main page window; and a width of the candidate information page is the same as a width of the additional information window.

In the embodiment of the present disclosure, the intercepting the target information for display in the additional information window from the candidate information page based on the page scroll distance and determining the first line position of the target information based on the page scroll distance includes: pre-setting a mapping relationship between the page scroll distance and the first line position of the target information; and determining the first line position of the target information based on the mapping relationship and according to the page scroll distance.

In the embodiment of the present disclosure, the candidate information page includes a plurality of pieces of candidate information, where a height of each piece of candidate information is the same as the height of the additional information window, and a width of each piece of candidate information is the same as the width of the additional information window; and pre-setting the mapping relationship between the page scroll distance and the first line position of the target information includes: determining a plurality of page scroll intervals based on the height of the additional information window; and establishing a mapping relationship between each of the plurality of page scroll intervals and a first line information position of one piece of candidate information in the plurality of pieces of candidate information.

In the embodiment of the present disclosure, the candidate information page includes one or more pieces of candidate information, where a width of each piece of candidate information is the same as the width of the additional information window; and pre-setting the mapping relationship between the page scroll distance and the first line position of the target information includes: establishing a linear mapping relationship between the page scroll distance and the first line position of the target information.

Based on the above target information display method, an embodiment of the present disclosure further provides a target information display apparatus, including:
a target information obtaining module configured to intercept target information for display in an additional information window from a candidate information page based on the page scroll distance, where the additional information window is located in the main page window and moves with page scrolling of the main page window; and
a display module configured to display the target information in the additional information window.

In addition, an embodiment of the present disclosure further provides an electronic device, including: a memory, a processor, and a computer program stored on the memory and executable on the processor, where the processor, when executing the program, performs the above target information display method.

The embodiment of the present disclosure further provides a non-transitory computer-readable storage medium, where the non-transitory computer-readable storage medium stores computer instructions, and the computer instructions are used to cause a computer to perform the above target information display method.

The embodiment of the present disclosure further provides a computer program product, including computer program instructions, where the computer program instructions, when executed on a computer, cause the computer to perform the above target information display method.

In the above target information display method and apparatus, in the scrolling process of the main page window, the content of the target information displayed in the additional information window will scroll with the scrolling of the main page, so as to realize the switching of the content displayed therein. Therefore, the above target information display method can carry more target information in the limited additional information window space without limitation of the size of the additional information window, and since the size of the additional information window is always a preset window size, the user will not be excessively interfered. That is to say, the above method can carry more target information on the page on the premise of ensuring the user experience, thereby providing more references of additional information for the user.

### BRIEF DESCRIPTION OF THE DRAWINGS

In order to more clearly illustrate the technical solutions in the present disclosure or in the related art, the following will briefly introduce the drawings that need to be used in the description of the embodiments or the related art. Apparently, the drawings in the following description are only the embodiments of the present disclosure, and those skilled in the art can obtain other drawings according to these drawings without creative efforts.

FIG. 1 is a schematic diagram of an implementation scenario of displaying promotional information in a main page window;

FIG. 2 is a schematic flowchart of a target information display method according to an embodiment of the present disclosure;

FIG. 3 is a schematic diagram of an implementation scenario of displaying target information in a main page window according to some embodiments of the present disclosure;

FIG. 4 is a schematic diagram of another implementation scenario of displaying target information in a main page window according to other embodiments of the present disclosure;

FIG. 5 is a schematic diagram of an internal structure of a target information display apparatus according to an embodiment of the present disclosure; and

FIG. 6 shows a more specific schematic diagram of a hardware structure of an electronic device according to some embodiments of the present disclosure.

### DETAILED DESCRIPTION OF EMBODIMENTS

In order to make the purpose, technical solutions and advantages of the present disclosure more clear, the present disclosure will be further described in detail below with reference to specific embodiments and drawings.

It should be noted that, unless otherwise defined, technical or scientific terms used in the embodiments of the present disclosure should have the general meaning as understood by those of ordinary skill in the art to which the present disclosure belongs. “First”, “Second” and similar words used in the embodiments of the present disclosure do not indicate any order, quantity or importance, but are only used to distinguish different components. Words like “include” or “comprise” mean that elements or objects appearing in front of the word cover elements or objects listed after the word and their equivalents, without excluding other elements or objects. Words like “connect” or “connected” are not limited to physical or mechanical connections, but may include electrical connections, whether direct or indirect. “Up”, “down”, “left”, “right”, etc. are only used to indicate the relative positional relationship, and when the absolute position of the described object changes, the relative positional relationship may also change accordingly.

It can be understood that before using the technical solutions of each embodiment in the present disclosure, the user will be informed of the type, scope of use, use scenarios, etc. of the involved personal information in an appropriate manner, and the user's authorization will be obtained.

For example, in response to receiving an active request from a user, prompt information is sent to the user to clearly inform the user that the operation requested to be performed will require access to and use of the user's personal information. Therefore, the user can independently choose whether to provide personal information to software or hardware such as an electronic device, an application, a server or a storage medium that performs the operations of the technical solutions of the present disclosure according to the prompt information.

As an optional but not limited implementation, in response to receiving an active request from a user, the method of sending prompt information to the user may be, for example, a pop-up window, and the prompt information may be presented in text in the pop-up window. In addition, the pop-up window may also contain a selection control for the user to select “agree” or “disagree” to provide personal information to the electronic device.

It can be understood that the above process of notifying and acquiring user authorization is only illustrative, and does not limit the implementation of the present disclosure. Other methods that meet relevant laws and regulations can also be applied to the implementation of the present disclosure.

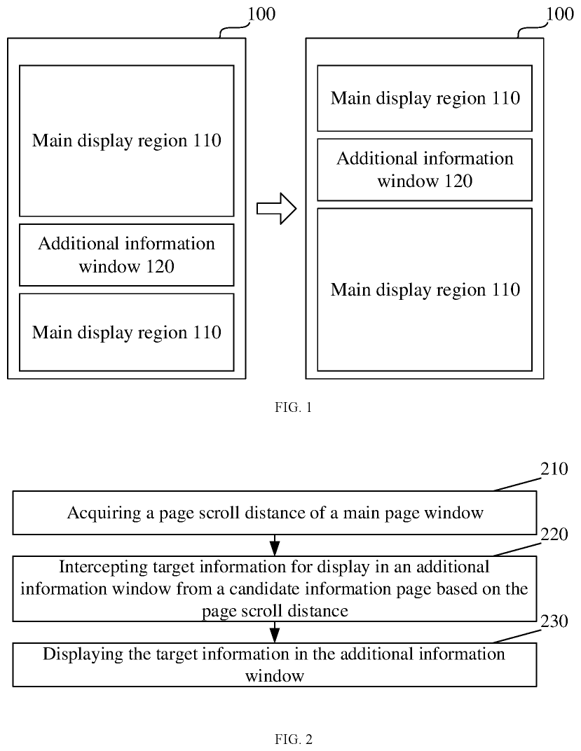

As mentioned above, in order not to excessively interfere with users, promotional information is currently usually mixed in a main page window in the form of an additional information window. FIG. 1 is a schematic diagram of an implementation scenario of displaying promotional information in a main page window. As shown in FIG. 1, a main page window 100 is displayed on a display screen of a user client (for example, a display screen of a mobile phone or a computer). In the above main page window 100, in addition to a main display region 110 for displaying its main function content, an additional information window 120 for displaying other information such as promotional information is also included. Generally, the position of the above additional information window will scroll with the scrolling of the page. As shown in FIG. 1, in the process of browsing the function content in the above main display region 110, if the user performs a scroll operation on the main page, for example, scrolls up the main page, the above additional information window 120 will usually scroll up with the upward scrolling of the main page. However, the content of the promotional information displayed in the above additional information window 120 is usually unchanged.

Considering the screen size of the client and avoiding excessive interference to users, the size of the additional information window set on the above main page window 100 is usually set to be small, and therefore, the amount of promotional information that can be carried in the additional information window is also usually very limited.

In order to solve the above problem, an embodiment of the present disclosure provides a target information display method, which can carry more target information in a limited additional information window space without being limited by the size of the additional information window. Specifically, in the embodiment of the present disclosure, the above target information may specifically be promotional information or other information different from the main function content displayed in the main display region 110. It should be noted that the specific content of the target information is not limited in the embodiments of the present disclosure.

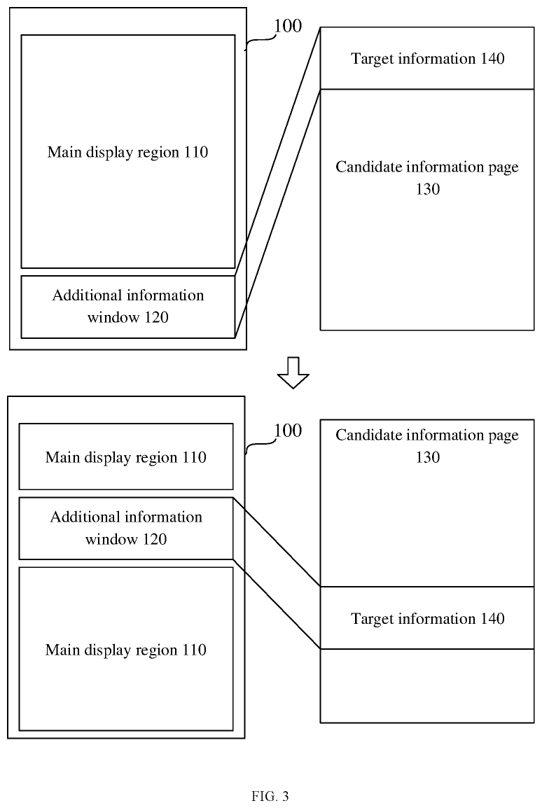

FIG. 2 shows a specific implementation flow of the target information display method according to the embodiment of the present disclosure. As shown in FIG. 2, the target information display method according to the embodiment of the present disclosure mainly includes the following steps.

At step 210, a page scroll distance of a main page window is acquired.

At step 220, target information for display in an additional information window is intercepted from a candidate information page based on the page scroll distance, where the additional information window is located in the main page window and moves with page scrolling of the main page window.

At step 230, the target information is displayed in the additional information window.

The specific implementation method of each step in the above target information display method will be described in detail below with reference to the drawings and specific examples.

For the above step 210, in the embodiment of the present disclosure, the above page scroll distance may specifically refer to the scroll height of the above main page window or the current position of the vertical scroll bar on the main page. It can be understood that when the user scrolls up and down the main page, the vertical scroll bar on the main page will move upward or downward accordingly. In the embodiment of the present disclosure, the above step 210 may specifically acquire the page scroll distance by the following method: firstly, listening for a page scroll event of the main page window: in response to listening for the page scroll event, reading a scroll height of the main page window; and finally, using the scroll height of the page window as the page scroll distance.

In order to realize the listening of the page scroll event of the above main page window, in a specific implementation, a scroll listening function handleScroll may be defined first, and a method for acquiring the scroll height of the main page window is defined in this function. Then, by calling the function window.addEventListener (‘scroll’, handleScroll), the listening event of the page scrolling of the main page window is added. In this way, the listening of the page scroll event of the main page window can be realized, that is, when the main page window container sends a scroll, the above scroll listening function handleScroll will be automatically called.

In addition, the scroll height of the above main page window may be obtained by reading an attribute value that represents the current position of the vertical scroll bar of the above main page window. For example, in some embodiments, it may be obtained by reading the window.scrollY attribute value or the window.pageYOffset attribute value of the main page window. Or, in other embodiments, it may be obtained by reading the document.documentElement.scrollTop attribute value of the main page window. It should be noted that the above different attribute values are only some examples of reading the scroll height of the main page window, and the purpose of using different attribute values is to be compatible with different browser pages. The embodiment of the present disclosure does not limit which attribute value of the window is specifically read to obtain the scroll height of the above main page window.

After the page scroll distance is determined, at the above step 220, the target information for display in the additional information window may be intercepted from the candidate information page based on the determined page scroll distance. In the embodiment of the present disclosure, the first line position of the target information may be determined based on the above page scroll distance first, and then the information within the height of the additional information window is intercepted as the target information starting from the first line position of the candidate information page. Specifically, the embodiment of the present disclosure provides a variety of specific methods for determining the first line position of the target information.

In order to carry more target information in a limited additional information window space, in the embodiment of the present disclosure, a candidate information page may be generated in advance. The above candidate information page may contain one or more pieces of candidate information. The content carried in the above candidate information page may be multimedia content such as text, image, video, etc. The form of the content carried in the above candidate information page is not limited in the embodiment of the present disclosure. The target information displayed in the above additional information window is intercepted from the above candidate information page based on the size of the additional information window.

In addition, generally, the width of the above candidate information page may be the same as the width of the above additional information window, so as to ensure that when displaying the target information contained in the candidate information page, the information will not be displayed incompletely due to the width of the target information exceeding the width of the additional information window. In the embodiment of the present disclosure, the height of the above candidate information page may usually be the same as the height of the above main page window, or may be different from the length of the above main page window.

In some embodiments, it is assumed that the height of the candidate information page is the same as the height of the main page window, and the width of the candidate information page is the same as the width of the additional information window. In this case, at the above step 220, the page scroll distance may be directly set as the first line position of the target information. In this way, it can ensure that the content of the target information displayed in the additional information window will scroll with the scrolling of the main page window. Moreover, when the main page window scrolls the entire height of the main page window, the target information displayed in the additional information window will also scroll the entire height of the candidate information page, that is, the entire candidate information page is displayed. FIG. 3 is a schematic diagram of an implementation scenario of displaying target information in a main page window according to the above embodiments. It can be seen that in the implementation scenario shown in FIG. 3, in the upward scrolling process of the main page window 100, not only the position of the additional information window 120 will move upward with the scrolling of the main page, but also the content of the target information 140 displayed therein will scroll upward with the upward scrolling of the main page, which is displayed as being generated by scrolling and intercepting the corresponding content from the candidate information page 130 from top to bottom. For example, when the acquired page scroll distance is 0, the first line position of the target information 140 is also 0, that is, the corresponding target information 140 will be displayed in the additional information window 120 starting from the first line position of the candidate information page 130, and the height of the displayed target information 140 is the height of the additional information window. When the acquired page scroll distance is m, the first line position of the target information 140 is also m, that is, the corresponding target information 140 will be displayed in the additional information window 120 starting from the position of the mth pixel in the vertical direction of the candidate information page 130, and the height of the displayed target information 140 is the height of the additional information window. Through the above method, the content on the above candidate information page 130 can be continuously displayed in the additional information window 120 with the scrolling of the main page window 100.

In other embodiments, it is not limited that the height of the candidate information page is the same as the height of the main page window, but only the width of the candidate information page is required to be the same as the width of the additional information window. In this case, the mapping relationship between the page scroll distance and the first line position of the target information may be pre-set, and then the first line position of the above target information may be determined according to the obtained page scroll distance based on the set mapping relationship.

In some embodiments of the present disclosure, the above mapping relationship may be a linear mapping relationship between the page scroll distance and the first line position of the target information. For example, let n=k×m: where n represents the first line position of the target information: m represents the acquired page scroll distance; and k is a set linear coefficient. It can be understood that when k≥1, the scroll speed of the target information displayed in the additional information window will be greater than or equal to the scroll speed of the main page window (the target information in the additional information window scrolls faster, which is suitable for the case where the height of the candidate information page is greater than the height of the main page window); while when k<1, the scroll speed of the target information displayed in the additional information window will be less than the scroll speed of the main page window (the target information in the additional information window scrolls slower, which is suitable for the case where the height of the candidate information page is less than the height of the main page window). In this case, an implementation scenario of displaying the target information in the main page window will be similar to the scenario shown in FIG. 3.

In other embodiments of the present disclosure, the above candidate information page may include a plurality of pieces of candidate information, where a height of each piece of candidate information is the same as the height of the additional information window, and a width of each piece of candidate information is the same as the width of the additional information window. In this way, a complete piece of candidate information may be displayed in the additional information window at a time. In order to realize the scrolling display of a plurality of pieces of candidate information one by one in the scrolling process of the main page, in the embodiment of the present disclosure, a plurality of page scroll intervals may be determined based on the height of the above additional information window first, and then a mapping relationship between each of the plurality of page scroll intervals and a first line information position of one piece of candidate information in the plurality of pieces of candidate information may be established respectively. In this way, the plurality of pieces of candidate information may be displayed one by one in the scrolling process of the main page. Assuming that the height of the main page window is H and the height of the additional information window is h, the above candidate information page may include

$$a = ⌊ \frac{H}{h} ⌋$$

pieces of candidate information. In the embodiment of the present disclosure, a plurality of scroll intervals [0,h), [h,2h), [2h,3h), . . . , [(a−2)h, (a−1)h), [(a−1)h,H] may be predetermined. Then, a mapping relationship between each of the above plurality of page scroll intervals and a first line information position of one piece of candidate information in the above plurality of pieces of candidate information is established respectively: the scroll interval [0,h) corresponds to the first line information position of the first piece of candidate information: the scroll interval [h,2h) corresponds to the first line information position of the second piece of candidate information: the scroll interval [2h,3h) corresponds to the first line information position of the third piece of candidate information . . . ; the scroll interval [(a−2)h,(a−1)h) corresponds to the first line information position of the (a−1)th piece of candidate information; and the scroll interval [(a−1)h,H] corresponds to the first line information position of the ath piece of candidate information. In this way, in the scrolling process of the main page, the first line position of the corresponding target information (that is, the first line information of a piece of candidate information) may be determined according to the scroll interval in which the page scroll distance falls. In this way, when the page scroll distance is always within a certain scroll interval, the target information displayed in the additional information window is unchanged. Only when the page scroll distance jumps from one scroll interval to another, the target information displayed in the additional information window will switch from one piece of candidate information to another piece of candidate information.

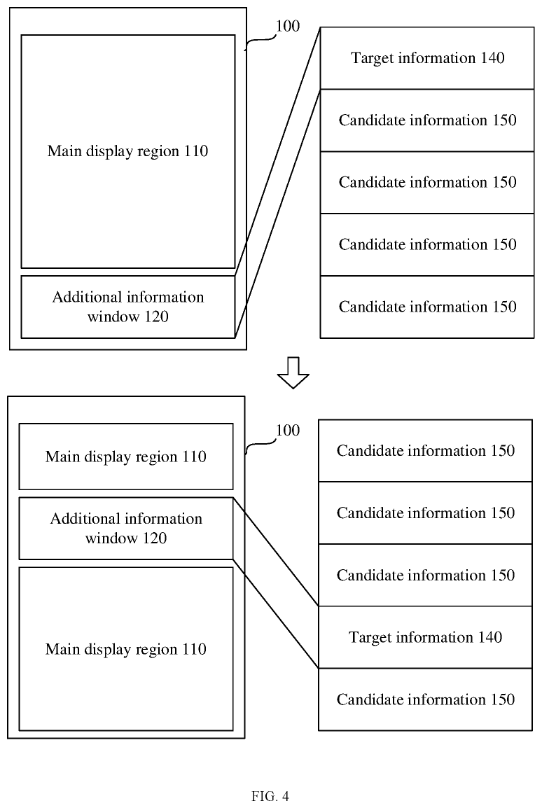

FIG. 4 is a schematic diagram of an implementation scenario of displaying target information in a main page window according to the above embodiments. It can be seen that in the implementation scenario shown in FIG. 4, in the upward scrolling process of the main page window, not only the position of the additional information window 120 will move upward with the upward scrolling of the main page, but also the content of the target information 140 displayed therein will scroll upward with the upward scrolling of the main page, and switch among a plurality of pieces of candidate information 150. For example, when the acquired page scroll distance is 0 to h, the first line position of the target information 140 is the first line position of the first piece of candidate information 150 in the candidate information page, that is, the first piece of candidate information will be displayed in the additional information window 120 at this time. When the acquired page scroll distance is h to 2h, the first line position of the target information 140 is the first line position of the second piece of candidate information 150 in the candidate information page, that is, the second piece of candidate information 150 will be displayed in the additional information window 120 at this time . . . ; when the acquired page scroll distance is (a−1)h to H, the first line position of the target information 140 is the first line position of the last piece of candidate information 150 in the candidate information page, that is, the last piece of candidate information 150 will be displayed in the additional information window 120 at this time. Through the above method, a plurality of pieces of candidate information 150 may be scrolled and displayed one by one in the additional information window 120 with the scrolling of the main page window.

Of course, it can be understood that in practical applications, the parameter h for determining the number of pieces of candidate information that can be included on the candidate information page and the plurality of scroll intervals in the above embodiments may also be modified to any other set information switch step s. At this time, the above candidate information page may include

$$a = ⌊ \frac{H}{s} ⌋$$

pieces of candidate information, and a plurality of scroll intervals are predetermined as [0,s), [s,2s), [2s,3s), . . . , [(a−2)s, (a−1)s), [(a−1)s,H]. In this way, it can be realized that when the page scroll distance reaches the above information switch step s, the target information displayed in the additional information window will be switched once. It can be understood that when the value of the above information switch step s is set to be relatively large, the switching speed of the candidate information displayed in the above additional information window will be relatively slow; while when the value of the above information switch steps is set to be relatively small, the switching speed of the candidate information displayed in the above additional information window will be relatively fast. Therefore, the size of the above information switch step s may be flexibly set according to business requirements, and the present disclosure does not limit this.

At the above step 220, after the above first line position is determined, since the size of the additional information window is predetermined, the information within the height of the additional information window may be intercepted as the target information directly starting from the above first line position of the candidate information page. In practical applications, after the width and height of the container corresponding to the additional information window are set and the first line position of the candidate information page displayed on the container is determined, the above information intercepting operation may usually be automatically implemented.

In this way, a visible region and a hidden region may be divided on the above candidate information page, where the size of the visible region is the size of the preset additional information window. In applications, the position of the above visible region on the above candidate information page may be determined according to the determined above first line position, so as to realize the division of the above visible region and the hidden region and the interception of the target information.

After the above target information is determined, the determined target information may be displayed in the additional information window at step 230.

It can be seen that in the target information display method described in the above embodiments, in the scrolling process of the main page window, not only the position of the additional information window will scroll with the scrolling of the main page, but also the content of the target information displayed therein will scroll with the scrolling of the main page, so as to realize the switching of the content displayed in the additional information window. Therefore, the above target information display method can carry more target information in the limited additional information window space without limitation of the size of the additional information window, and since the size of the additional information window remains unchanged, the target information displayed in the additional information window will not excessively interfere with the user. That is to say, the above method can carry more information on the page on the premise of ensuring the user experience, thereby providing more information references for the user.

Corresponding to the above target information display method, an embodiment of the present disclosure further discloses a target information display apparatus. FIG. 5 shows the internal structure of the target information display apparatus according to some embodiments of the present disclosure. As shown in FIG. 5, the above target information display apparatus may include the following modules.

A page scroll distance obtaining module 510 configured to acquire a page scroll distance of a main page window:

A target information obtaining module 520 configured to intercept target information for display in an additional information window from a candidate information page based on the page scroll distance, where the additional information window is located in the main page window and moves with page scrolling of the main page window; and

A display module 530 configured to display the target information in the additional information window.

For the specific implementation of each of the above modules, reference may be made to the foregoing method and the drawings, which will not be repeated here. For the convenience of description, when describing the above apparatus, various modules are described separately according to functions. Of course, when implementing the present disclosure, the functions of each module may be implemented in the same or more pieces of software and/or hardware. The apparatus of the above embodiment is used to implement the corresponding target information display method in any of the foregoing embodiments, and has the beneficial effects of the corresponding method embodiment, which will not be repeated here.

Based on the same inventive concept, corresponding to any of the above embodiment methods, the present disclosure further provides an electronic device, including: a memory, a processor, and a computer program stored on the memory and executable on the processor, where the processor, when executing the program, performs the target information display method of any of the above embodiments.

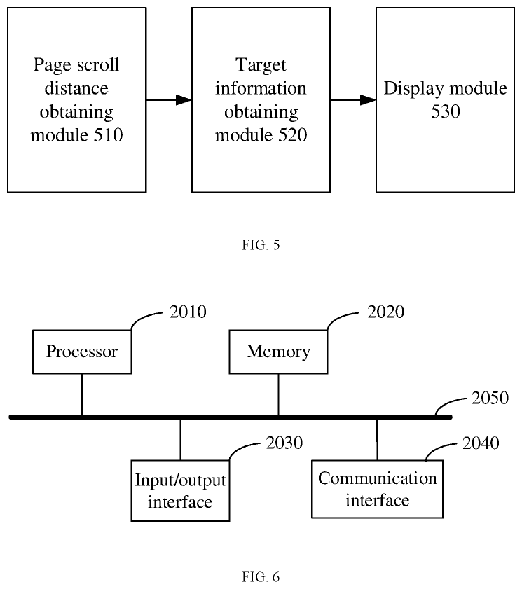

FIG. 6 shows a more specific schematic diagram of a hardware structure of an electronic device provided by the present embodiment. The device may include a processor 2010, a memory 2020, an input/output interface 2030, a communication interface 2040, and a bus 2050. The processor 2010, the memory 2020, the input/output interface 2030 and the communication interface 2040 realize communication connection between each other inside the device through the bus 2050.

The processor 2010 may be implemented in a general-purpose Central Processing Unit (CPU), a microprocessor, an Application Specific Integrated Circuit (ASIC), or one or more integrated circuits, etc., and is configured to execute related programs to implement the technical solutions provided in the embodiments of the present specification.

The memory 2020 may be implemented in the form of Read Only Memory (ROM), Random Access Memory (RAM), static storage device, dynamic storage device, etc. The memory 2020 may store an operating system and other application programs. When implementing the technical solutions provided in the embodiments of the present specification through software or firmware, related program codes are stored in the memory 2020 and called by the processor 2010 for execution.

The input/output interface 2030 is configured to connect to input/output devices to realize information input and output. The input/output devices may be configured in the device as components, or may be connected to the device externally to provide corresponding functions. The input devices may include a microphone, various sensors, etc., and the output devices may include a display, a speaker, a vibrator, an indicator light, etc.

The communication interface 2040 is configured to connect to a communication module (not shown in the figure) to realize communication interaction between the present device and other devices. The communication module may realize communication in a wired manner (for example, USB, network cable, etc.), or may realize communication in a wireless manner (for example, mobile network, WIFI, Bluetooth, etc.).

The bus 2050 includes a path for transmitting information between components (for example, the processor 2010, the memory 2020, the input/output interface 2030 and the communication interface 2040) of the device.

It should be noted that although the above device only shows the processor 2010, the memory 2020, the input/output interface 2030, the communication interface 2040, and the bus 2050, in a specific implementation process, the device may also include other components necessary for normal operation. In addition, it can be understood by those skilled in the art that the above device may only contain components necessary for implementing the solutions of the embodiments of the present specification, and does not necessarily contain all the components shown in the figure.

The electronic device of the above embodiment is used to implement the corresponding target information display method in any of the foregoing embodiments, and has the beneficial effects of the corresponding method embodiment, which will not be repeated here.

Based on the same inventive concept, corresponding to any of the above embodiment methods, the present disclosure further provides a non-transitory computer-readable storage medium, where the non-transitory computer-readable storage medium stores computer instructions, and the computer instructions are used to cause a computer to perform the target information display method of any of the above embodiments.

The computer-readable medium of the present embodiment includes permanent and non-permanent, removable and non-removable media, which may be implemented by any method or technology for information storage. The information may be computer-readable instructions, data structures, program modules, or other data. Examples of computer storage media include, but are not limited to, phase change memory (PRAM), static random access memory (SRAM), dynamic random access memory (DRAM), other types of random access memory (RAM), read only memory (ROM), electrically erasable programmable read only memory (EEPROM), flash memory or other memory technology, compact disc read only memory (CD-ROM), digital versatile disc (DVD) or other optical storage, magnetic cassette, magnetic tape magnetic disk storage or other magnetic storage devices or any other non-transmission medium, which may be used to store information that can be accessed by computing devices.

The computer instructions stored in the storage medium of the above embodiments are used to cause the computer to perform the task processing method of any of the above embodiments, and have the beneficial effects of the corresponding method embodiment, which will not be repeated here.

Those of ordinary skill in the art should understand that the discussion of any of the above embodiments is only exemplary, and is not intended to imply that the scope of the present disclosure (including the claims) is limited to these examples. Under the idea of the present disclosure, the technical features in the above embodiments or different embodiments may also be combined, the steps may be implemented in any order, and there are many other changes in different aspects of the embodiments of the present disclosure as described above, which are not provided in detail for the purpose of brevity.

In addition, in order to simplify the description and discussion, and in order not to make the embodiments of the present disclosure difficult to understand, the well-known power/ground connections of integrated circuit (IC) chips and other components may or may not be shown in the provided drawings. In addition, the apparatus may be shown in the form of a block diagram, so as to avoid making the embodiments of the present disclosure difficult to understand, and this also takes into account the fact that the details of the implementation of these block diagram apparatuses are highly dependent on the platform on which the embodiments of the present disclosure are to be implemented (that is, these details should be completely within the understanding of those skilled in the art). In the case where specific details (for example, circuits) are set forth to describe exemplary embodiments of the present disclosure, it is obvious to those skilled in the art that the embodiments of the present disclosure may be implemented without these specific details or with changes in these specific details. Therefore, these descriptions should be considered as illustrative rather than restrictive.

Although the present disclosure has been described in connection with specific embodiments of the present disclosure, many alternatives, modifications, and variations of these embodiments will be apparent to those of ordinary skill in the art from the foregoing description. For example, other memory architectures (for example, dynamic RAM (DRAM)) may use the discussed embodiments.

The embodiments of the present disclosure are intended to cover all such alternatives, modifications, and variations that fall within the broad scope of the appended claims. Therefore, any omission, modification, equivalent replacement, improvement, etc. made within the spirit and principles of the embodiments of the present disclosure shall be included in the protection scope of the present disclosure.

What is claimed is:

1. A target information display method, comprising:
acquiring a page scroll distance of a main page window;
intercepting target information for display in an additional information window from a candidate information page based on the page scroll distance, wherein the additional information window is located in the main page window and moves with page scrolling of the main page window; and
displaying the target information in the additional information window.

2. The method of claim 1, wherein acquiring the page scroll distance comprises:
monitoring a page scroll event of the main page window;
in response to the page scroll event monitored, reading a scroll height of the main page window; and
using the scroll height of the page window as the page scroll distance.

3. The method of claim 2, wherein reading the scroll height of the main page window comprises:
reading an attribute value that represents a current position of a vertical scroll bar of the main page window as the scroll height of the page window.

4. The method of claim 3, wherein the attribute value that represents the current position of the vertical scroll bar of the main page window comprises: a window.scrollY attribute value, a window.pageYOffset attribute value, or a document.documentElement.scrollTop attribute value.

5. The method of claim 1, wherein intercepting the target information for display in the additional information window from the candidate information page based on the page scroll distance comprises:
determining a first line position of the target information based on the page scroll distance; and
intercepting information within a height of the additional information window starting from the first line position of the candidate information page as the target information.

6. The method of claim 5, wherein determining the first line position of the target information based on the page scroll distance comprises: setting the page scroll distance as the first line position of the target information.

7. The method of claim 6, wherein: a height of the candidate information page is the same as a height of the main page window; and a width of the candidate information page is the same as a width of the additional information window.

8. The method of claim 5, wherein determining the first line position of the target information based on the page scroll distance comprises:
pre-setting a mapping relationship between the page scroll distance and the first line position of the target information; and
determining the first line position of the target information based on the mapping relationship and according to the page scroll distance.

9. The method of claim 8, wherein the candidate information page comprises a plurality of pieces of candidate information, wherein a height of each piece of candidate information is the same as the height of the additional information window, and a width of each piece of candidate information is the same as the width of the additional information window; and
pre-setting the mapping relationship between the page scroll distance and the first line position of the target information comprises:
determining a plurality of page scroll intervals based on the height of the additional information window; and
establishing a mapping relationship between each of the plurality of page scroll intervals and a first line information position of one piece of candidate information in the plurality of pieces of candidate information.

10. The method of claim 8, wherein the candidate information page comprises one or more pieces of candidate information, wherein a width of each piece of candidate information is the same as the width of the additional information window; and
pre-setting the mapping relationship between the page scroll distance and the first line position of the target information comprises: establishing a linear mapping relationship between the page scroll distance and the first line position of the target information.

11. An electronic device, comprising: a memory, a processor, and a computer program stored on the memory and executable on the processor, wherein the processor, when executing the program, performs a target information display method, comprising:
acquiring a page scroll distance of a main page window;
intercepting target information for display in an additional information window from a candidate information page based on the page scroll distance, wherein the additional information window is located in the main page window and moves with page scrolling of the main page window; and
displaying the target information in the additional information window.

12. The electronic device of claim 11, wherein acquiring the page scroll distance comprises:
monitoring a page scroll event of the main page window;
in response to the page scroll event monitored, reading a scroll height of the main page window; and
using the scroll height of the page window as the page scroll distance.

13. The electronic device of claim 12, wherein reading the scroll height of the main page window comprises: reading an attribute value that represents a current position of a vertical scroll bar of the main page window as the scroll height of the page window.

14. The electronic device of claim 13, wherein the attribute value that represents the current position of the vertical scroll bar of the main page window comprises: a window.scrollY attribute value, a window.pageYOffset attribute value, or a document.documentElement.scrollTop attribute value.

15. The electronic device of claim 11, wherein intercepting the target information for display in the additional information window from the candidate information page based on the page scroll distance comprises:
determining a first line position of the target information based on the page scroll distance; and
intercepting information within a height of the additional information window starting from the first line position of the candidate information page as the target information.

16. A non-transitory computer-readable storage medium storing computer instructions, wherein the computer instructions are used to cause a computer to perform a target information display method, comprising:
acquiring a page scroll distance of a main page window;
intercepting target information for display in an additional information window from a candidate information page based on the page scroll distance, wherein the additional information window is located in the main page window and moves with page scrolling of the main page window; and
displaying the target information in the additional information window.

17. The non-transitory computer-readable storage medium of claim 16, wherein acquiring the page scroll distance comprises:
monitoring a page scroll event of the main page window;
in response to the page scroll event monitored, reading a scroll height of the main page window; and
using the scroll height of the page window as the page scroll distance.

18. The non-transitory computer-readable storage medium of claim 17, wherein reading the scroll height of the main page window comprises: reading an attribute value that represents a current position of a vertical scroll bar of the main page window as the scroll height of the page window.

19. The non-transitory computer-readable storage medium of claim 18, wherein the attribute value that represents the current position of the vertical scroll bar of the main page window comprises: a window.scrollY attribute value, a window.pageYOffset attribute value, or a document.documentElement.scrollTop attribute value.

20. The non-transitory computer-readable storage medium of claim 16, wherein intercepting the target information for display in the additional information window from the candidate information page based on the page scroll distance comprises:
determining a first line position of the target information based on the page scroll distance; and
intercepting information within a height of the additional information window starting from the first line position of the candidate information page as the target information.
